(19) United States
(12) Patent Application Publication
(10) Pub. No.: US 2009/0174193 A1
(43) Pub. Date: Jul. 9, 2009

(54) AC/DC system for powering a vehicle

(76) Inventors: Andrew A. Steger, Lynchburg, VA (US); Fred A. Steger, JR., McAllen, TX (US)

Correspondence Address: PETER J. VAN BERGEN, 402 WEST DUKE OF GLOUCESTER STREET, WILLIAMSBURG, VA, 23185, US

(21) Appl. No.: 12/381,723

(22) Filed: Mar. 16, 2009

Related U.S. Application Data
(63) Continuation-in-part of application No. 11/700,506, filed on Jan. 31, 2007, now abandoned.

(51) Int. Cl. F03D 9/02; H02K 53/00

(52) U.S. Cl. 290/55; 180/65.22; 415/916

(57) ABSTRACT

A system for powering a vehicle includes a DC motor adapted to be coupled to a vehicle axle when the vehicle is to be driven in reverse or forward at a speed less than a threshold, and an AC motor adapted to be coupled to vehicle axle when it is to be driven forward at a speed exceeding the threshold. An AC generator adapted to be driven during motion of the vehicle generates an AC current for powering the AC motor when the AC generator is coupled thereto. An operator-controlled rheostat is used to control the speed of either the AC or DC motor. A switching system uncouples the AC generator from the AC motor and couples a battery to the DC motor through the rheostat when the vehicle is driven in reverse or forward at a speed less than the threshold. The switching system also serves to uncouple the battery from the DC motor and couple the AC generator to the AC motor through the rheostat when the vehicle is driven forward at a speed exceeding the threshold.

This is a continuation-in-part of co-pending application Ser. No. 11/700,506, filed Jan. 31, 2007. Pursuant to 35 U.S.C. §120, the benefit of priority from co-pending application Ser. No. 11/700,506 is hereby claimed for this application.

### FIELD OF THE INVENTION

The invention relates generally to electric powered vehicles, and more particularly to a vehicle powering system that uses both alternating current (AC) and direct current (DC) electric power.

### BACKGROUND OF THE INVENTION

The problems associated with gasoline-powered vehicles are very well known. Environmental concerns, geo-political tensions, and economic crises can all be linked to the use of gasoline to power the world's vehicles. Accordingly, efforts are being made to design and develop vehicles that require either less gasoline (e.g., hybrid vehicles) or no gasoline (e.g., fuel cell vehicles, electric vehicles, etc.). While many of these vehicles show promise, none has emerged as a “clear choice” replacement for traditional gasoline-powered vehicles. The reasons for this are varied and include excessive cost, unproven technologies, vehicles that are underpowered for their intended purpose or the environment in which they will be used, lack of infrastructure to handle “re-fueling” of vehicles utilizing new technologies, etc.

### SUMMARY OF THE INVENTION

Accordingly, it is an object of the present invention to provide a system for powering a vehicle that does not use gasoline.

Another object of the present invention is to provide an electric power system for a vehicle utilizing well known and safe technologies.

Still another object of the present invention is to provide an electric power system for a vehicle that utilizes motion of the vehicle in the powering process.

Other objects and advantages of the present invention will become more obvious hereinafter in the specification and drawings.

In accordance with the present invention, a system for powering a vehicle includes a DC motor adapted to be coupled to a vehicle axle when the vehicle is to be driven in reverse or forward at a speed less than a threshold. A battery is provided to power the DC motor when coupled thereto. The system further includes an AC motor adapted to be coupled to a vehicle axle when it is to be driven forward at a speed exceeding the threshold, and at least one motion-powered AC generator adapted to be driven by motion of the vehicle. The AC generator generates an AC current for powering the AC motor when the AC generator is coupled thereto. An operator-controlled rheostat is used to control the speed of either the AC or DC motor. A provided switching system links the DC motor, battery, AC motor, AC generator and rheostat. Specifically, the switching system uncouples the AC generator from the AC motor and couples the battery to the DC motor through the rheostat when the vehicle is driven in reverse or forward at a speed less than the threshold. In this configuration, the vehicle is powered by the DC motor. The switching system also serves to uncouple the battery from the DC motor and couple the AC generator to the AC motor through the rheostat when the vehicle is driven forward at a speed exceeding the threshold. In this configuration, the vehicle is powered by the AC motor.

### BRIEF DESCRIPTION OF THE DRAWINGS

Other objects, features and advantages of the present invention will become apparent upon reference to the following description of the preferred embodiments and to the drawings, wherein corresponding reference characters indicate corresponding parts throughout the several views of the drawings and wherein:

FIG. 1 is a schematic view of an AC/DC electric power system for a vehicle in accordance with the present invention;

FIG. 2 is a schematic view of an AC/DC electric power system for a vehicle utilizing a passive-axle generator in the generation of AC power in accordance with an embodiment of the present invention;

FIG. 3 is a schematic view of an AC/DC electric power system for a vehicle utilizing wind-powered generators in the generation of AC power in accordance with another embodiment of the present invention; and

FIG. 4 is an isolated schematic view of a motion-powered AC generation system in accordance with another embodiment of the present invention.

### DETAILED DESCRIPTION OF THE INVENTION

Referring now to the drawings and more particularly to the sole FIGURE, a system for powering a vehicle using DC and AC electrical power is shown and is referenced generally by numeral 10. While system 10 could be adapted for use in a variety of types of vehicles, it is well-suited for land-based vehicles such as passenger automobiles. Accordingly, the present invention will be explained for its use in vehicles that have axles coupled to the vehicle's wheels. Typically, the present invention will be employed on vehicles having at least two axles and four wheels. However, it is to be understood that the present invention could be used with vehicles having fewer or more axles/wheels without departing from the scope of the present invention. For clarity of illustration, the present invention is shown driving a single axle. However, it is further to be understood that the present invention could be used to drive multiple axles without departing from the scope of the present invention. In addition, system 10 will typically include a variety of conventional electrical components (e.g., resistors, capacitors, etc.) that have been omitted for clarity of illustration. Such conventional electrical components and the use thereof are well understood in the art.

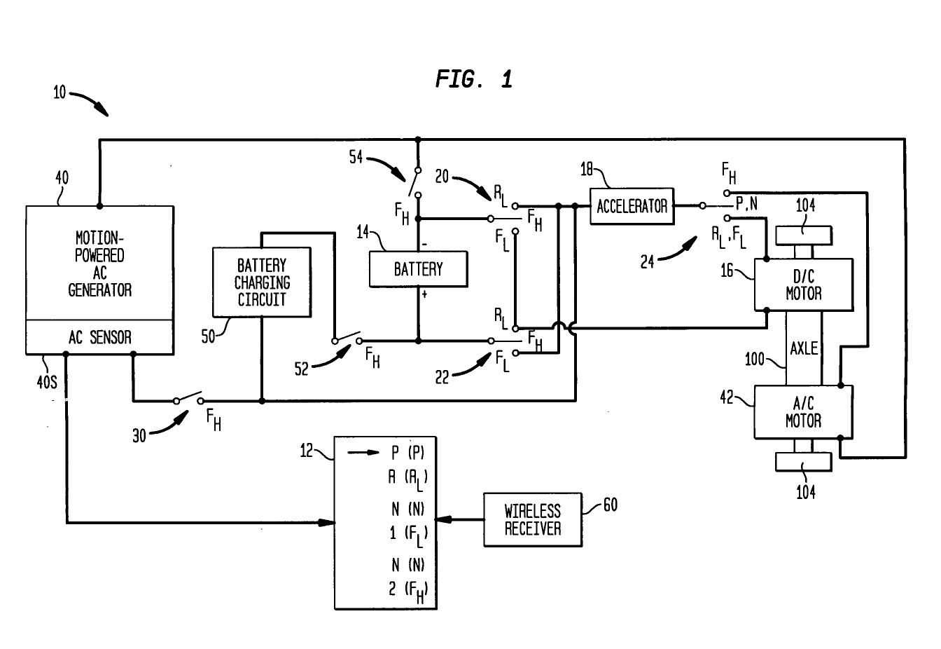

In general, system 10 uses either DC power or AC power to bring about mechanical motion (e.g., rotation) of a vehicle axle 100 having wheels 104 coupled to the outboard ends thereof. More specifically, at slow vehicle speeds, DC power is used while AC power is used for faster vehicle speeds. The transition between slow and fast vehicle speeds is governed in the illustrated example by a user-controlled switcher 12 (maintained on the vehicle) having a number of user-selected settings such as park (“P”), reverse (“R”), neutral (“N”), forward at slow speeds (“1”), and forward at faster speeds (“2”). Additional or alternate settings could also be employed without departing from the scope of the present invention. Switcher 12 is used to configure system 10 for one of AC or DC power for the vehicle operating in one of a reverse mode, a forward mode at a slow speed, and a forward mode at a higher speed. Accordingly, switcher 12 can be made to appear like a standard vehicle gearshift in the passenger compartment of the vehicle. Note that the park “P” and neutral “N” settings of switcher 12 define open switch (or relay) positions illustrated in FIG. 1 and explained further below. The neutral “N” position can be used between the various vehicle movement settings to give the switches time to transition to a different vehicle movement setting.

Since a vehicle typically starts from a stopped position when accelerating in reverse or just starting to move forward, both the reverse mode and forward mode at a slow speed are well-suited to utilize DC power.

Specifically, system 10 includes a battery 14 and a reversible DC motor 16 to supply DC powered energy directly to axle 100. For example, DC motor 16 can include a slip clutch (not shown) for direct coupling of the motor's rotational components to axle 100. In this example, the motor's slip clutch would be configured to engage axle 100 when DC motor 16 receives power and disengage from axle 100 when DC motor 16 does not receive power.

Control of the DC power to thereby control the speed of the vehicle is achieved by routing the DC power from battery 14 to DC motor 16 through the vehicle's accelerator 18 which is essentially a user-controlled rheostat. The DC power is routed from battery 14 through accelerator 18 to DC motor 16 via a series of switches 20, 22 and 24 that are coupled to switcher 12 (e.g., via a hardwired connection not shown in the figures in order to maintain illustration clarity). That is, the position of each of switches 20, 22 and 24 is set based on the setting of switcher 12. For example, when the vehicle's switcher 12 is placed in the park (“P”) or neutral (“N”) settings, switch 24 is opened so that accelerator 18 is uncoupled from both DC motor 16 and an AC motor 42 (which is similarly “slip clutch” coupled to axle 100). In the reverse setting, switches 20, 22 and 24 are set to the “R_{L}” position and battery 14 is coupled to DC motor 16 through accelerator 18 such that DC motor 16 causes axle 100 to rotate such that reverse motion is imparted to the vehicle. When switcher 12 is placed in the forward setting at a slow speed, switches 20, 22 and 24 are set to the “F_{L}” position and the current polarity is changed (relative to the reverse setting) such that axle 100 now imparts forward motion to the vehicle. In either case, the speed of the vehicle is adjusted by the user via accelerator 18.

At a desired threshold speed, system 10 is switched over to AC power. The threshold speed essentially defines the highest speed for DC power and the lowest speed for AC power. The particular threshold speed is a design choice that is not a limitation of the present invention. Switching to AC power can be accomplished manually (e.g., by the user changing the setting of switcher 12) or it could be governed by an automatic switching controller (not shown) when there is sufficient AC power being generated for use by the present invention as will be explained further below. Accordingly, the threshold speed can be defined in terms of actual vehicle speed and/or an AC current/voltage/power level needed to operate AC motor 42. For safety reasons, it may be desirable to prevent the vehicle from being driven too fast in reverse.

For this reason, switching from DC power to AC power could be limited to forward settings of switcher 12 as is the case with the illustrated example of the present invention.

When switcher 12 is switched to the forward setting at a higher speed or “2”, switches 20 and 22 are set to the “F_{H}” position which uncouples battery 14 from DC motor 16. As a result of losing power, DC motor 16 is uncoupled from axle 100 so that axle 100 is no longer powered thereby. At the same time, switches 24 and 30 are set so that a motion-powered AC generator 40 is coupled to AC motor 42 which, in turn, is coupled to axle 100. That is, similar to DC motor 16, AC motor 42 is “slip clutch” coupled to axle 100 so that its rotational components directly engage axle 100 when receiving electrical power. The AC power generated by AC generator 40 is supplied to AC motor 42/axle 100 in a user-controlled amount by (rheostat) accelerator 18.

In general, the term “motion-powered AC generator” as used herein refers to any device or system that can utilize one or more facets of vehicle motion to turn or rotate the electricity-generating mechanism (i.e., rotor within a stator) of an AC generator such that AC voltage/power is generated. As would be understood by one of ordinary skill in the art, AC generator 40 would typically include one or more transformers (not shown) to convert the generated AC voltage/power to levels required by various onboard systems.

Such transformers are well understood in the art. AC generator 40 could also incorporate a conventional AC (current, voltage or power) sensor/monitor 40S to indicate when AC generator 40 is producing AC current/voltage/power (hereinafter referred to simply as “AC”) at a level that can sustain operation of AC motor 42. The sensing of sufficient AC can be used to provide a driver with a visual and/or audible indication that the vehicle can be operated using AC power. Additionally or alternatively, the sensing of sufficient AC can be used to automatically switch vehicle operation to AC power (e.g., automatically control switcher 12 to change from the F_{L} to the F_{H} position).

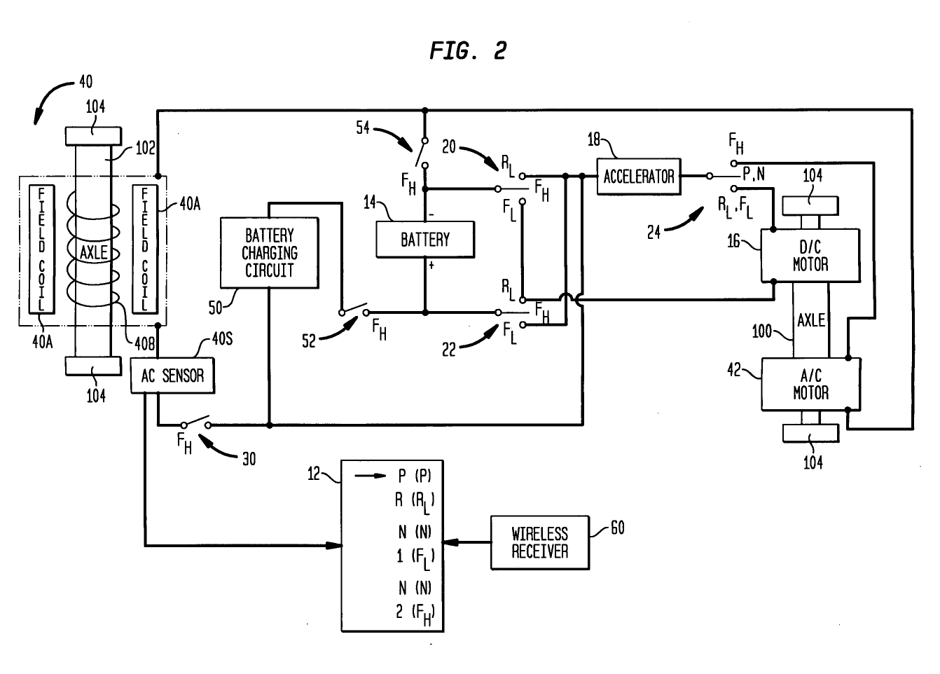

Motion-powered AC generator 40 can be configured and constructed in a variety of ways to take advantage of vehicle motion in order to generate AC. For example, AC generator 40 could be configured to use the rolling motion of the vehicle as shown in FIG. 2 where AC generator 40 includes a stationary field coil 40A disposed about an armature coil 40B that is wound about an axle 102. Axle 102 can be a “passive” axle in that its rotation is brought about solely by vehicle motion that is imparted to axle 102 via wheels 104 engaging a ground surface. Accordingly, as axle 102 rotates during any vehicle motion, AC generator 40 generates AC power. The AC power is used to power the vehicle once the vehicle has attained its desired threshold speed, i.e., once AC sensor 40S detects the generation of sufficient AC.

As described above and referring again to FIG. 1, battery 14 supplies the power for low-speed vehicle operation via DC motor 16. Typically, battery 14 will be some sort of rechargeable cell(s). The recharging of battery 14 can occur during vehicle down time (e.g., at night) by coupling battery 14 to a conventional battery charger (not shown). Additionally or alternatively, system 10 can be equipped with an onboard battery charging capability. That is, system 10 can be equipped to recharge battery 14 during operation of the vehicle at higher speeds when AC generator 40 is operating. In such a case, a battery charging circuit 50 can be provided and coupled to battery 14 for the charging thereof. The coupling of battery charging circuit 50 into and out of system 10 is governed by switches 52 and 54. Similar to the other switches in system 10, the positions of switches 52 and 54 can be set by switcher 12. Additionally or alternatively, switches 52 and 54 could be governed by AC generator 40. That is, charging of battery 14 might only be permitted when AC generator 40 is generating a surplus of AC as monitored by AC sensor 40S as described above. Battery charging circuit 50 would typically include voltage rectification and other signal conditioning circuitry as would be well understood in the art.

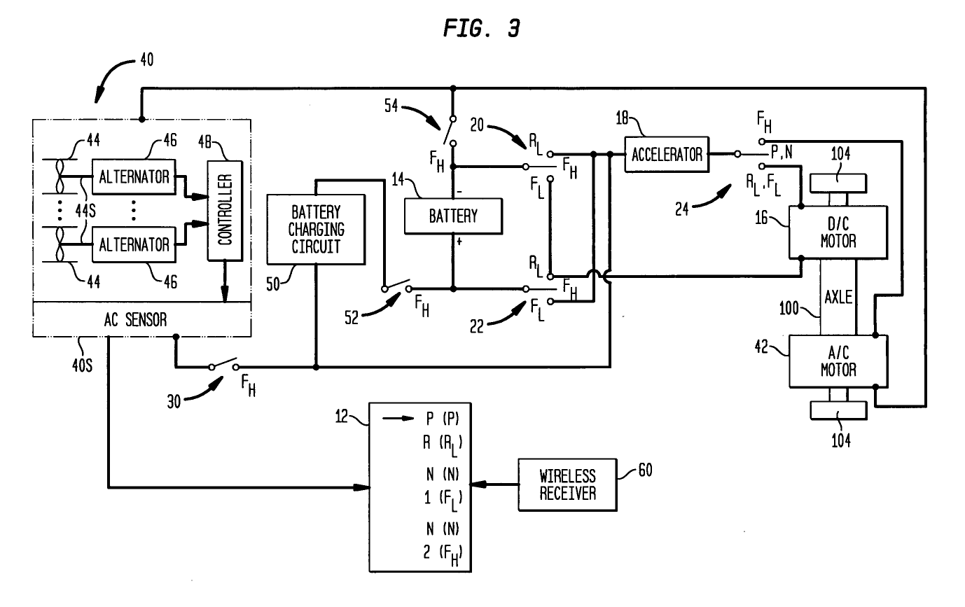

The embodiment illustrated in FIG. 2 may not produce sufficient AC voltage/power in certain instances (e.g., when a vehicle is traveling uphill). Accordingly, the present invention can include other embodiments of motion-powered AC generator 40 in an additive or alternative configuration. For example, another embodiment of the electricity-generating portion of motion-powered AC generator 40 illustrated in FIG. 3 utilizes wind as the motive force to turn generator 40. This embodiment could be combined with the features of AC generator 40 in FIG. 2 or used in place thereof without departing from the scope of the present invention.

In the FIG. 3 embodiment, the wind can be apparent wind generated by vehicle motion as well as ambient wind in the surrounding environment. To capture both forms of wind, AC generator 40 in FIG. 3 will typically utilize two or more propellers (or impellers) 44. Each propeller 44 can be positioned to capture wind coming from a different direction.

For example, one propeller 44 could be mounted to face the front of the vehicle (e.g., behind the vehicle's front grille) while a second propeller 44 could be mounted to face the side or rear of the vehicle. Each propeller 44 could be fixed in its orientation or can be movable in orientation to achieve optimum performance without departing from the scope of the present invention. Such orientation control of propellers is well-known in the art. The rotating shaft of each propeller 44 causes the rotor (not shown) of a corresponding alternator 46 to turn and generate AC voltage/power. That is, each propeller/alternator combination essentially defines an AC generator. A controller 48 sums the AC voltage/power from alternators 46.

The use of multiple propellers 44 also provides for differing “cut in” (i.e., start-up) wind speeds. That is, one propeller 44 could be configured for a low “cut in” wind speed while a second propeller 44 could be configured for a higher “cut in” wind speed.

The advantages of the present invention are numerous. The all-electric vehicle power system does not require any gasoline or other fossil fuel. The system should be suitable for many basic passenger vehicle applications, especially highway driving where vehicle motion remains fairly constant for relatively long periods or in locales where wind is a prevalent atmospheric condition. Use of apparent and ambient wind utilizes a free and readily available energy source. Environmentally, the system will reduce both air and noise pollution. Complex gear and drive train mechanisms are virtually eliminated as the axle(s) are directly driven by the rotating components of either the DC or AC motors.

Although the invention has been described relative to specific embodiments thereof, there are numerous variations and modifications that will be readily apparent to those skilled in the art in light of the above teachings. For example, if high levels of electric current will pass through the system, the system's “switches” could include high-current-handling relays to handle the actual current flow. The system can be adapted to a variety of motor and generator configurations without departing from the scope of the present invention. The various elements of the system can be positioned for optimum efficiency depending on the vehicle type, application, and the environment in which it will be used. For example, each of the DC and AC motors and AC generator could be coupled to a separate axle. The AC generator could be mechanically or electronically “subtracted” from the system when the vehicle is operating on DC power to minimize drag on the system operating at low speeds.

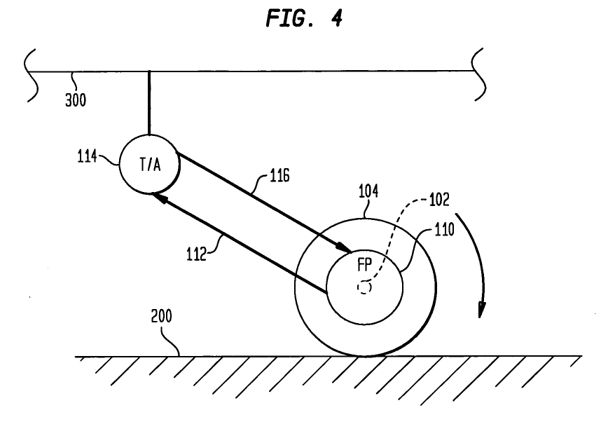

As mentioned above in the description of FIG. 1, motion-powered AC generator 40 is indicative of one of more such AC generators that can utilize the same or different aspects of vehicle motion. By way of example, FIG. 4 illustrates another type of motion-powered AC generator that uses vehicle wheel motion to turn a fluid pump whose pumped fluid is used to drive a turbine/alternator for the generation of AC voltage/power. Briefly, an internal paddle wheel (not shown) of a fluid pump (“FP”) 110 is coupled to an axle 102 having a wheel 104 coupled thereto for rotation on a ground surface 200. When axle 102 rotates with wheel 104, the internal paddle wheel of fluid pump 110 rotates to pump fluid through a closed system. The closed system includes a conduit carrying fluid in the direction of arrow 112 to a turbine/alternator (“T/A”) 114 mounted to (e.g., suspended from) some portion of a vehicle 300. The pumped fluid causes a rotor (not shown) of turbine/alternator 114 to rotate and generate AC voltage/power. The fluid is returned to fluid pump 110 via a conduit indicated by arrow 116. Enablement/disablement of this system can be controlled manually or automatically without departing from the scope of the present invention. When enabled, this motion-powered AC voltage/power generation embodiment can be used in an additive or alternative sense to the wind-based motion-powered AC generator(s).

In addition to the above-described variations, the particular “low speed-to-high speed threshold” could be changed to suit user preferences, driving applications, environments, or habits. The setting of this threshold could be factory set, user-controlled, government-controlled, or even automatically adjusted. For example, each of the above-described embodiments of the present invention could also include a wireless receiver 60 coupled to switcher 12. In this way, a wireless signal could be used to adjust the threshold speed when a vehicle entered a particular geographic region, a region defined by a specific kind of driving (e.g., flat terrain, hilly terrain, highway driving, etc.), or when wind conditions in a region warrant such adjustment. The wireless signal could be generated at various fixed stations (e.g., existing cellular phone towers) distributed throughout the country. In the absence of a wireless signal, switcher 12 can default to factory settings.

It is therefore to be understood that, within the scope of the appended claims, the invention may be practiced other than as specifically described.

What is claimed as new and desired to be secured by Letters Patent of the United States is:

1. A system for powering a vehicle, comprising:
a DC motor adapted to be coupled to an axle of a vehicle when the vehicle is to be driven in reverse or forward at a speed less than a threshold;
a battery for powering said DC motor when coupled thereto;
an AC motor adapted to be coupled to an axle of the vehicle when the vehicle is to be driven forward at a speed exceeding said threshold;
at least one motion-powered AC generator adapted to be driven during motion of the vehicle wherein an alternating current is generated thereby for powering said AC motor when said AC generator is coupled thereto;
an operator-controlled rheostat; and
switching means coupled to said DC motor, said battery, said AC motor, said AC generator and said rheostat, for uncoupling said AC generator from said AC motor and coupling said battery to said DC motor through said rheostat when the vehicle is driven in reverse or forward at a speed less than said threshold wherein the vehicle is powered by said DC motor, and for uncoupling said battery from said DC motor and coupling said AC generator to said AC motor through said rheostat when the vehicle is driven forward at a speed exceeding said threshold wherein the vehicle is powered by said AC motor.

2. A system as in claim 1 further comprising a battery charging circuit electrically coupled between said AC generator and said battery by said switching means when the vehicle is driven forward at a speed exceeding said threshold.

3. A system as in claim 1 wherein said at least one AC generator is powered by wind.

4. A system as in claim 1 wherein said at least one AC generator comprises a plurality of wind-powered AC generators.

5. A system as in claim 1 wherein said switching means includes an operator-controlled switch positionable to one of a plurality of settings to include a reverse setting when the vehicle is to be driven in reverse at a speed less than said threshold, a first forward setting when the vehicle is to be driven forward at a speed less than said threshold, and a second forward setting when the vehicle is to be driven forward at a speed that exceeds said threshold.

6. A system as in claim 1 further comprising a wireless receiver coupled to said switching means for receiving a value for said threshold in a wireless fashion.

7. A system as in claim 1 further comprising means, coupled to said AC generator and said switching means, for monitoring said alternating current wherein operation of said switching means is controlled by said alternating current so-monitored.

8. A system for powering a vehicle, comprising:
a user-operated control switchable between a plurality of settings to include a reverse setting for reverse vehicle speeds up to a threshold speed, a first forward setting for forward vehicle speeds up to said threshold speed, and a second forward setting for forward vehicle speeds that exceed said threshold speed;
a DC motor adapted to be coupled to an axle of a vehicle when said control is in one of the reverse setting and the first forward setting;
a battery for powering said DC motor when coupled thereto;
an AC motor adapted to be coupled to the axle of the vehicle when said control is in the second forward setting;
at least one motion-powered AC generator adapted to be driven during motion of the vehicle wherein an alternating current is generated thereby for powering said AC motor when said AC generator is coupled thereto;
an operator-controlled rheostat; and
switching means coupled to said DC motor, said battery, said AC motor, said AC generator and said rheostat, said switching means further coupled to said control for uncoupling said AC generator from said AC motor and coupling said battery to said DC motor through said rheostat when said control is in one of the reverse setting and first forward setting, and for uncoupling said battery from said DC motor and coupling said AC generator to said AC motor through said rheostat when said control is in the second forward setting.

9. A system as in claim 8 further comprising a battery charging circuit electrically coupled between said AC generator and said battery by said switching means when the gearshift is in the second forward setting.

10. A system as in claim 8 wherein said at least one AC generator is powered by wind.

11. A system as in claim 8 wherein said at least one AC generator comprises a plurality of wind-powered AC generators.

12. A system as in claim 8 further comprising a wireless receiver coupled to said control for receiving a value for said threshold speed in a wireless fashion.

13. A system as in claim 8 further comprising means, coupled to said AC generator and said switching means, for monitoring said alternating current wherein operation of said switching means is controlled by said alternating current so-monitored.

14. A system for powering a vehicle, comprising:
a user-operated control switchable between a plurality of settings to include a reverse setting for reverse vehicle speeds up to a threshold speed, a first forward setting for forward vehicle speeds up to said threshold speed, and a second forward setting for forward vehicle speeds that exceed said threshold speed;
a wireless receiver coupled to said control for receiving a value indicative of said threshold speed in a wireless fashion;
a DC motor adapted to be coupled to an axle of a vehicle when said control is in one of the reverse setting and the first forward setting;
a battery for powering said DC motor when coupled thereto;
an AC motor adapted to be coupled to the axle of the vehicle when said control is in the second forward setting;
at least one wind-powered AC generator adapted to be driven during motion of the vehicle wherein an alternating current is generated thereby for powering said AC motor when said AC generator is coupled thereto;
an operator-controlled rheostat; and
switching means coupled to said DC motor, said battery, said AC motor, said AC generator and said rheostat, said switching means further coupled to said control for uncoupling said AC generator from said AC motor and coupling said battery to said DC motor through said rheostat when said control is in one of the reverse setting and first forward setting, and for uncoupling said battery from said DC motor and coupling said AC generator to said AC motor through said rheostat when said control is in the second forward setting.

15. A system as in claim 14 further comprising a battery charging circuit electrically coupled between said AC generator and said battery by said switching means when the gearshift is in the second forward setting.

16. A system as in claim 14 wherein said at least one AC generator comprises a plurality of wind-powered AC generators.

17. A system as in claim 14 further comprising means, coupled to said AC generator and said switching means, for monitoring said alternating current wherein operation of said switching means is controlled by said alternating current so-monitored.
